(19) United States
(12) Patent Application Publication
(10) Pub. No.: US 2015/0262279 A1
(43) Pub. Date: Sep. 17, 2015

(54) ONE VIEW USER INTERFACE

(71) Applicants: BIKASH MOHANTY, MUMBAI (IN); SIDHARTH KHANNA, MUMBAI (IN)

(72) Inventors: BIKASH MOHANTY, MUMBAI (IN); SIDHARTH KHANNA, MUMBAI (IN)

(21) Appl. No.: 14/322,068

(22) Filed: Jul. 2, 2014

(30) Foreign Application Priority Data
Mar. 12, 2014 (IN) 827/MUM/2014

(51) Int. Cl. G06Q 30/06

(52) U.S. Cl. CPC G06Q 30/0623

(57) ABSTRACT

A one view user interface for enabling prolific viewing of products and related information is described. The one view system user interface includes: a consolidated view of supplier, category or business unit on one platform encompassing information about its spend, contracts, supplier performance programs, sourcing events and purchase orders/invoices in order to enable the user to view information pertaining to supplier, category or business unit. The system avoids the user having to log in into different product portals to view related information or data, thereby helping the user to know the supplier related information while remaining in any one of the procurement tools and the user is not required to switch over from one product to another product.

### CROSS-REFERENCE TO RELATED APPLICATION

The instant application claims priority to Indian Patent Application Serial No. 827/MUM/2014, filed Mar. 12, 2014, pending, the entire specification of which is expressly incorporated herein by reference.

### FIELD OF THE INVENTION

The present invention relates generally to computer user interfaces, and more particularly to one view user interface for enabling prolific view of product and its related information.

### BACKGROUND OF THE INVENTION

Network-enabled computing devices with graphical user interfaces, such as computer workstations and cellular telephones, often provide users with a web browser to view and interact with Internet web pages. Web pages are often defined by the website developer to be displayed in a specific manner that may not be ideal for all users. Some web browsers provide users with the ability to override certain functions and attributes of web pages, such as preventing the display of distracting ads. However, current web browsers are incapable of displaying just the portions of web pages a user selects and or the prolific view as desired in product based display. Therefore, there exists a need to have a one view feature whereby the user can access the webpage to obtain more detailed and relevant information.

### OBJECTS OF THE INVENTION

In order to overcome the problems associated as discussed in background, there exists a need to provide a system, whose functionality is not restricted to a particular sector of the commercial industry but which can be used for multiple applications.

An object of the invention is to have a one view user interface for enabling prolific view of product and its related information.

Yet another object of the present invention is to depict the product related information and provide to the user in order to perform procurement performance analysis.

Yet another object of the present invention is to have one view user interface on a mobile device such that, the user is not at all required to log in into different procurement tools but can access the one view data of the supplier directly through mobile apps.

It is an important object of the present invention to provide consolidated view of supplier, category or business unit on one platform encompassing information about its Spend, Contracts, Supplier Performance Programs, Sourcing Events and Purchase Orders/Invoices using one view.

Other features and embodiments are described further below. It will be understood that the present invention may be implemented in a variety of data processing systems, such as general purpose computers, handheld computers, embedded systems, cellular telephones, and other consumer electronic devices. It will also be understood that the present invention may be implemented in software which is stored on a computer readable medium which will cause a data processing system to perform one or more of the methods described herein.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is one view search box wherein user can search desired product and its specific information;

FIG. 2 is an illustration of key elements of one view featuring supplier report card, location through map, comment box and date range selection;

FIG. 3, is an illustration of summary and detail mode of one view;

FIG. 4 is an illustration of information cards of one view;

FIG. 5 is an illustration of restricted view within one view; and

FIGS. 6a, 6b and 6c are illustrations of one view work flow.

### DETAILED DESCRIPTION OF THE INVENTION

The subject invention will be described with reference to numerous details set forth below, and the accompanying drawings will illustrate the invention. The following description and drawings are illustrative of the invention and are o be construed as limiting the invention. Numerous specific details are described to provide a thorough understanding of the present invention. However, in certain instances, well known or conventional details are not described in order to not unnecessarily obscure the present invention in detail.

As used herein, the term “mobile device” is intended to encompass any form of programmable computing device as may exist or will be developed in the future which implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices), multimedia Internet enabled cellular telephones (e.g., the BLACKBERRY STORM™, and similar personal electronic devices that include a wireless communication module, processor and memory.

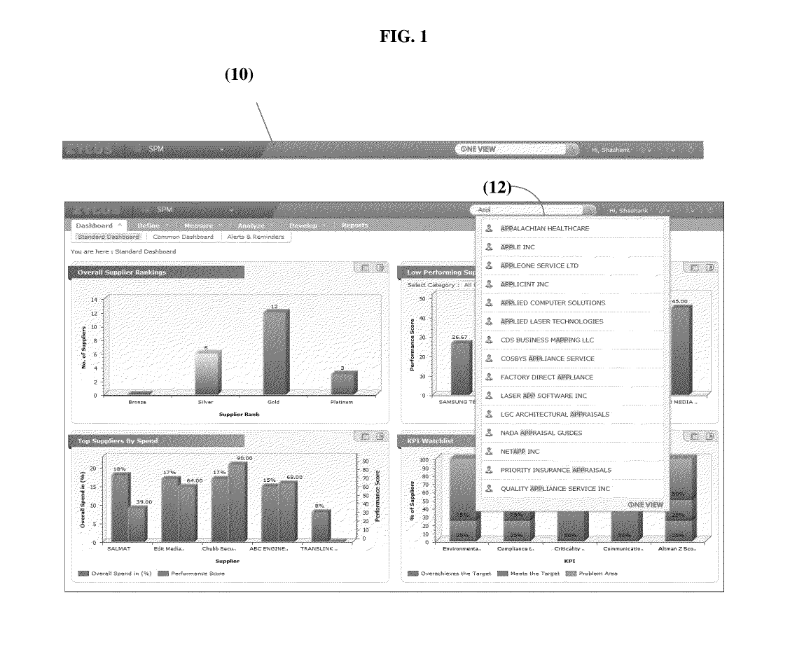

As shown in FIG. 1 there is provided a one view search box (10) in order to enable user to view information pertaining to supplier, category or business unit. The system avoids having the user log in into different product portals to view related information or data, thereby helping the user to know the supplier related information while remaining in any one of the procurement tools and the user is not required to switch over from one product to another product.

As shown in FIG. 1, the user can make use of a search tool (12) that provides consolidated view of supplier, category or business unit on one platform encompassing information about its spend, contracts, supplier performance programs, sourcing events and purchase orders/invoices.

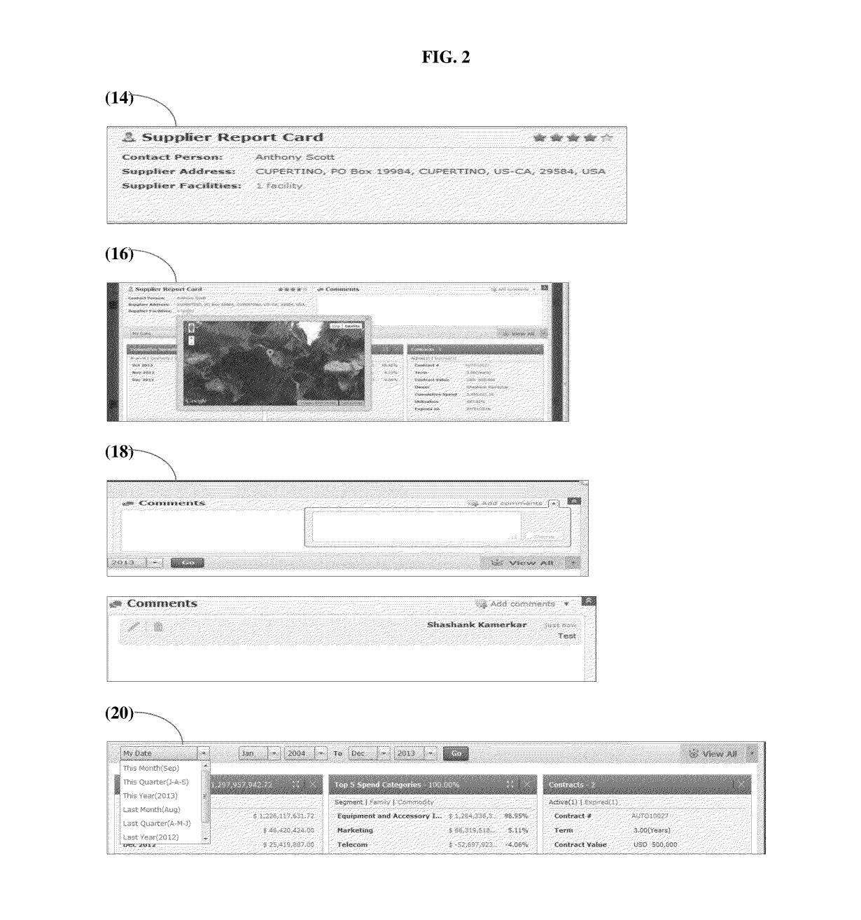

The key elements of the one view system as shown in FIG. 2, provides supplier report card, location through map, comment box and date range selection. The one view system displays the supplier information fetched from the supplier information management system at the top, as shown in FIG. 2. Attribute and performance score (14) of the supplier has been shown by attributing stars at the right top corner of the supplier report card. The supplier report card information is based on the supplier performance score for the supplier from the latest supplier performance program. The user also has the privilege to allocate stars based on his experience and perception of the supplier report card.

Further, FIG. 2 also depicts the provision of providing the location of the supplier through a map (16), provided the address of the supplier is recorded. Therefore, if the user, while performing a search, put category or business unit and a category report or business unit report card, then the user will get the respective report card to view.

Another feature that the one view system provides, as shown in FIG. 2, is a comment box (18) and date range selection by the user, whereby the user can use the comment box for adding comments about the supplier and or category and or business unit. The user can edit and delete comments posted by him, as well as respond to the comments posted in the comment box in relation to the relevant supplier and/or category and/or business unit. Further, the user may use a quick date filter option that enables him to select a specific time frame from a default set. As shown in FIG. 2, the date range may be manually selected from a quick date filter that may display a ‘My Date’ option (20) that is a user specific option, whereby the default selected date range taken is of the current year. Alternately, the date ranges selected by the user may always appear as a default date range for respective users.

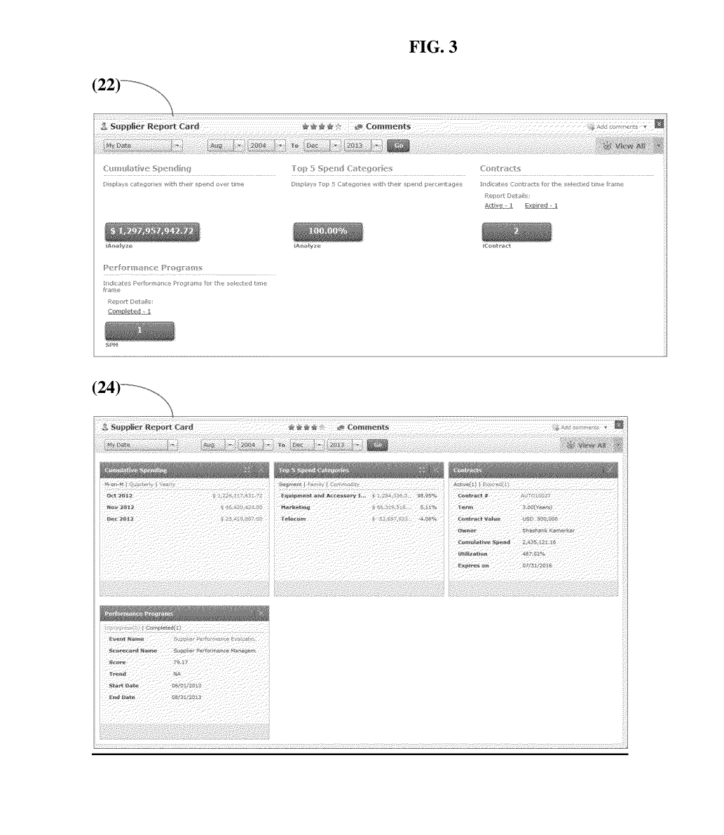

The user may choose to have view all options that open the entire card simultaneously when the view is in summary mode (22) as shown in FIG. 3. Therefore, it provides both a summary as well as a detail mode (24) of the supplier report card.

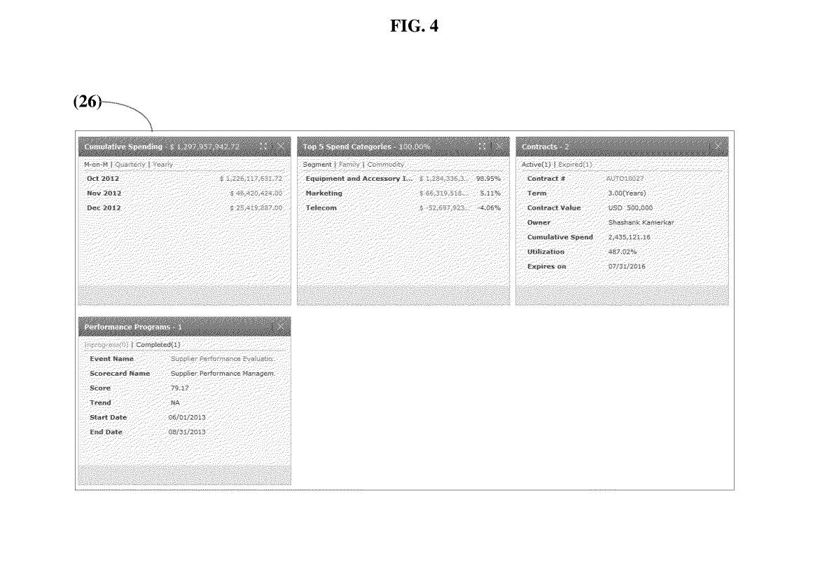

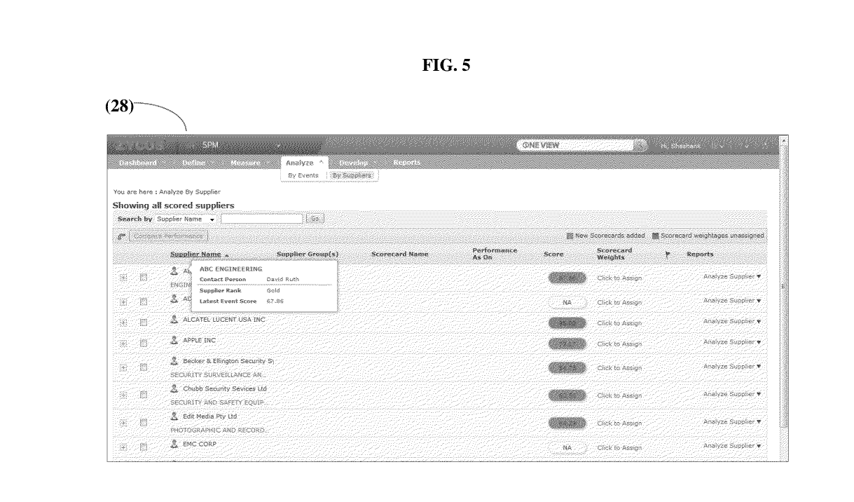

FIG. 4 illustrates the information cards (26) that are nothing but the information displayed in the one view system. Thus, the information card provides information on spend, contracts, supplier performance programs and sourcing event such as purchase orders and/or invoices for a selected time frame for the user specific supplier, category or business unit.

As shown in FIG. 4, the user is able to view cumulative spending cards and the top five (5) spend categories through a power analysis report for a specified period of time for a desired supplier in the form of a detailed analysis. Similarly, the user is able to view a contract of a respective supplier subject to the availability and access to the information. The user is also able to view a supplier performance under an event name category.

The one view system is also able to provide a restricted view (28) option, whereby the consolidated view of any supplier is user specific and a restricted view, such as contractual details, is not visible to the user. Similarly, based on other decision rules, there is restriction within the consolidated view. However, there is a provision to have an approval from the user's manager to access the restricted views, whereby the user is then able to view all the desired details, and such approval logs are tracked by the tool of the system.

The one view system can be deployed on mobile device and is available on ANDROID™ and iOS™ enabled handheld devices.

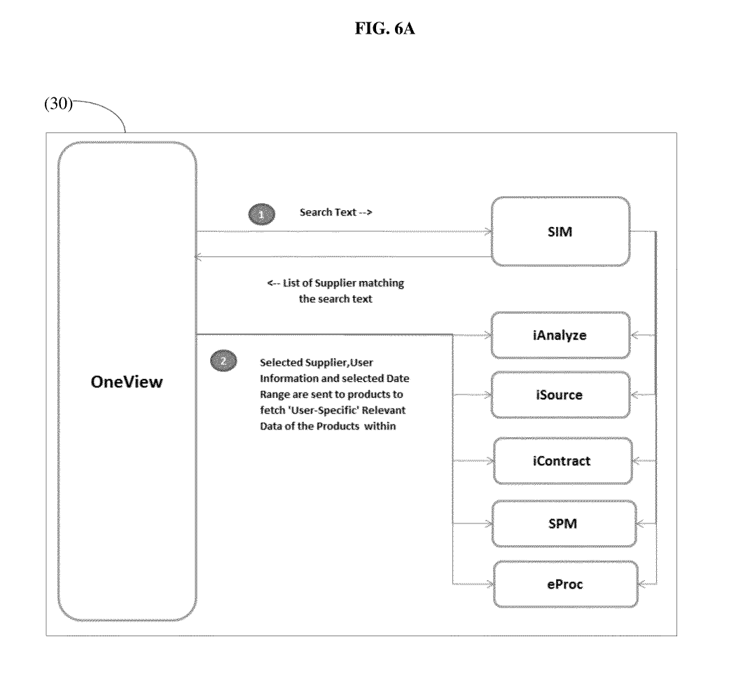

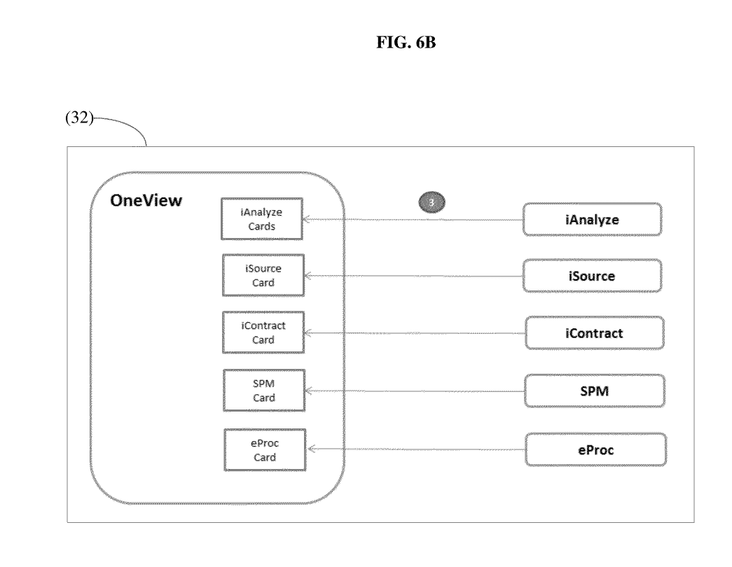

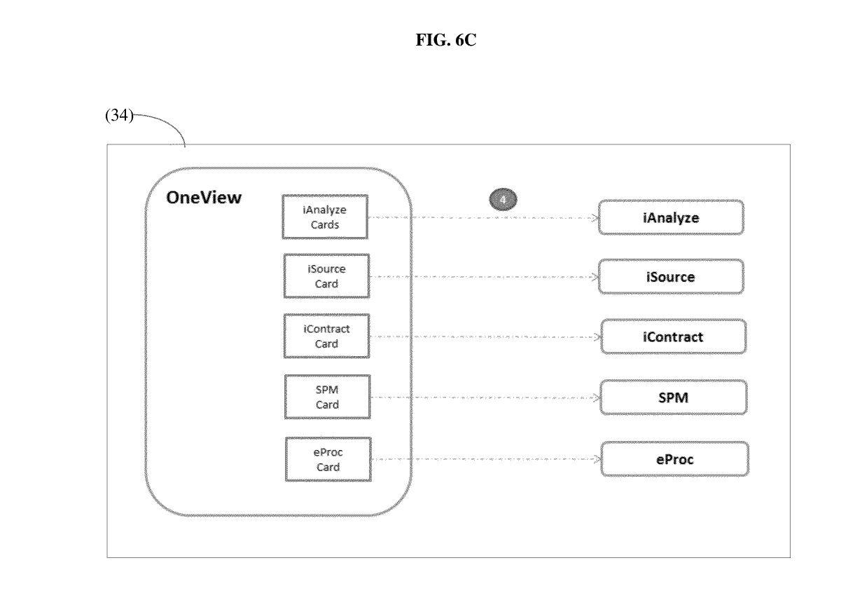

A method for implementing the system is also provided, as shown in FIG. 6, wherein the one view system enables the user to fetch pertinent information from various products that gets filtered through user restricted view decision rules before getting displayed to the user. Thus, the restricted decision rules are user configurable.

As shown in FIG. 6, the data is available in the iAnalyze cards, such as cumulative spending and the top five (5) spend categories that are configured as per the decision rules that are available to the iAnalyze user. Similarly, for other relevant cards, the data available in one view is based on the roles and authorization of the users.

As shown in FIG. 6a, when the user enters a search query for a product, the search text is send to the supplier information management system that in turn sends the list of suppliers matching the search query. Upon receiving the search results, the user is able to select supplier, supplier information or identification, user information with specified date range sent to all the products in order to fetch relevant product data from the respective products. Thus, the user is able to directly click on the required supplier's name instead of conducting separate searches for the supplier, thereby the user will get the desired product's information and its supplier information, supplier identification, user information, last selected date range, as well as default date range. The product specific data fetched from all the products is displayed in the respective product information cards.

The user is also able to further create a report of the product search obtained using one view, whereby the user clicks on the ‘More’ option in order to generate the desired report having details such as contact number, event name, supplier product management, user information and selected date range.

Thus, the described system and method provide ease to the user from manually deriving product and its supplier's data. The system provides consolidated data to the user at the end by generating a report.

While considerable emphasis has been placed herein on the structures and structural interrelationships between the component parts of the preferred embodiments, it will be appreciated that many embodiments can be made and that many changes can be made in the preferred embodiments without departing from the principals of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A one view system user interface, comprising:
a consolidated view of supplier, category or business unit on one platform including information about its spend, contracts, supplier performance programs, sourcing events and purchase orders/invoices in order to enable a user to view information pertaining to supplier, category or business unit, said system avoiding the user having to log in into different product portals to view related information or data, thereby helping the user to know supplier related information while remaining in any one of a plurality of procurement tools and the user is not required to switch over from one product to another product.

2. The system as claimed in claim 1, wherein said system provides a supplier report card, location through map, comment box and date range selection, thereby enabling the user to locate, as well as get a performance score, of said supplier.

3. The system as claimed in claim 1, wherein said system includes a user specific My Date option, whereby date ranges selected by the user always appear as a default date range for respective users, or alternately, the default selected date range taken is of a current year.

4. The system as claimed in claim 1, wherein the user has an option to view a supplier report in either a summary mode or a detail mode.

5. The system as claimed in claim 1, wherein an information card provides information on spend, contracts, supplier performance programs and sourcing event including purchase orders or invoices for a selected time frame for a user specific supplier, category or business unit.

6. The system as claimed in claim 1, wherein said system provides a restricted view option, whereby the consolidated view of any supplier is a user specific and restricted view, wherein contractual details are not visible to the user.

7. The system as claimed in 1, wherein said system is used in mobile devices or personal electronic devices that include a wireless communication module, processor and memory.
